(19) United States
(12) Patent Application Publication
(10) Pub. No.: US 2023/0221176 A1
(43) Pub. Date: Jul. 13, 2023

(54) APPARATUS FOR MEASURING A LIGHT BEAM PROFILE

(71) Applicant: WaveCyber Corporation, Saitama-shi (JP)

(72) Inventors: Daichi SHIRAYAMA, Saitama-Shi (JP); Mamoru AMADA, Saitama-shi (JP); Ryuichi MORITA, Saitama-shi (JP)

(21) Appl. No.: 17/845,570

(22) Filed: Jun. 21, 2022

(30) Foreign Application Priority Data
Jan. 11, 2022 (JP) 2022-011309

(51) Int. Cl. G01J 1/42

(52) U.S. Cl. CPC G01J 1/4228; G01J 2001/4261

(57) ABSTRACT

Provided is an apparatus for measuring a light beam profile, comprising three rotary disks fixed on three positions of a rotary shaft connected to a motor at regular intervals, respectively while shifted by 120 degrees each other in a rotational direction, each rotary disk having three deformed holes with knife edges and six deformed holes defining light-passing openings and a photodetector arranged outside a set of the three rotary disks in a transmission direction of the light beam to receive the light beam passing through the three rotary disks.

### BACKGROUND OF THE INVENTION

### 1. Field of the Invention

The present invention relates to an apparatus for measuring a light beam profile.

### 2. Description of the Related Art

In a manufacturing site, it is frequently required to correctly grasp a status of a light beam to adjust an optical system. As a conventional apparatus or method to measure a beam diameter of a light beam, there is one indicated in FIG. 2.

The method uses a rotary drum 10 arranged across a light beam to be measured. The rotary drum 10 has three or more knife edges or slits 14a, 14b and 14c formed on a peripheral face, the knife edges or slits 14a, 14b and 14c having different direction angles. A photodetector 16 is arranged inside the rotary drum 10. According to rotation of the rotary drum 10, the photodetector 16 measures a change in light power of the light beam. Based on the measurement, a beam diameter and a center of the light beam are calculated. In the method, a reciprocating mechanism (not illustrated) is provided for a measurement head (not illustrated) for a light beam profile to measure a direction angle and a spreading property of the light beam. With the reciprocating mechanism, the measurement head is moved to at least three positions in a transmission direction of the light beam. During the movement, the beam diameter and the center of the light beam are measured at each position to calculate characteristics such as the direction angle and the spreading angle of the light beam.

The method, however, requires time to move the measurement head and it is impossible to measure the direction angle and the like as well as the beam diameter and the center of the light beam in real time. On the other hand,

JP6899524B illustrated in FIG. 3 teaches a technique to measure the direction angle and the like in a short time. The technique uses a rotary drum 10 with three or more knife edges or slits 14a, 14b and 14c and light-passing openings 13a, 13b, 13c, 13d and 13e formed on a peripheral face. Inside the rotary drum 10, a half mirror 11 and a reflection mirror 12 are arranged. Outside the rotary drum 10, first and second photodetectors 16 and 17 are arranged. The technique, therefore, involves increase in size of the apparatus.

### SUMARY OF THE INVENTION

An object of the present invention is to provide an apparatus for measuring a light beam profile using a small and simple mechanism, to measure characteristics such as a transmission direction, a waist position and a spreading angle of a light beam to be measured with high accuracy as well as a beam diameter and the like of the light beam in real time.

In order to accomplish the object, an aspect of the present invention provides an apparatus for measuring a light beam profile, the apparatus including three rotary disks. The three rotary disks are integrally rotatable and arranged across a light beam to be measured at intervals on an optical path of the light beam. A plurality of deformed holes are formed through each of the three rotary disks and are arranged on a same or common circumference. Three deformed holes in the plurality of the deformed holes define knife edges or slits, respectively. Remaining deformed holes in the plurality of the deformed holes define light-passing openings as passages for the light beam, respectively.

The three rotary disks may be fixed to a rotary shaft connected to a motor while shifted by 120 degrees each other in a rotational direction. The three rotary disks are integrally rotatable. The three rotary disks may be fixed on three positions of the rotary shaft at regular intervals.

A photodetector is arranged outside the set of the three rotary disks on the optical path of the light beam to receive the light beam passing through the three rotary disks. The three rotary disks scan the radiated light beam at three points on the optical path with the knife edges or the slits during a single rotation of the three rotary disks, to allow a light beam profile of the radiated light beam to be measured.

In the measurement of the light beam profile, the photodetector receiving the scanned light beam generates an output signal corresponding to the scanned light beam. The output signal is input into a computer to calculate a center and a beam diameter of the light beam. Based on the calculation, a direction angle, a spreading angle and the like of the light beam are easily calculated using data of the intervals between the rotary disks.

Further, a bandpass filter may be arranged between an inlet port and the photodetector on the optical path of the light beam to reflect visible radiation only. In this case, a visible light source is arranged to be oriented to the bandpass filter at a position not to interfere the rotary disks. A collimator beam as a visible radiation beam radiated from the visible light source is reflected by the bandpass filter and is exited from the inlet port of the light beam to be measured. The exited visible collimator beam is used as a guide light for an optical axis of the apparatus. This results in facilitating installation of the apparatus for measuring a light beam profile.

The aspect measures a light beam profile such as a beam diameter, a center, intensity distribution and a transmission direction (direction angle) of the light beam to be measured at the three positions on the optical path of the light beam using the single photodetector in real time without reciprocating a measurement head. The apparatus is reduced in size in a transverse direction relative to the transmission direction of the light beam to be measured by arranging the three rotary disks in series in the transmission direction of the light beam to be measured.

### BRIEF DESCRIPTION OF THE DRAWINGS

FIG. 1 is a plan view illustrating a rotary disk having deformed holes used in an apparatus for measuring a light beam according to an embodiment of the present invention;

FIG. 2 is a side view illustrating a conventional apparatus for measuring a light beam profile;

FIG. 3 is a side view illustrating another conventional apparatus for measuring a light beam profile;

FIG. 4 is a side view illustrating the apparatus for measuring a light beam according to the embodiment;

FIG. 5 is a schematic perspective view illustrating the apparatus for measuring a light beam according to the embodiment;

FIG. 6 is a conceptual view illustrating a relation of positions to scan a light beam;

FIG. 7 is a side view illustrating the apparatus for measuring a light beam according to an alternative embodiment of the present invention; and

FIG. 8 is a plan view illustrating a rotary disk according to an alternative embodiment of the present invention.

### DETAILED DESCRIPTION OF EMBODIMENTS

Embodiments according to the present invention provide an apparatus for measuring a light beam profile, to measure characteristics such as a transmission direction, a waist position and a spreading angle of a light beam with high accuracy in real time.

The apparatus according to the embodiment has three rotary disks being integrally rotatable and arranged across a light beam to be measured at intervals on an optical path of the light beam. In one embodiment, the three rotary disks are fixed on three positions of a rotary shaft connected to a motor at regular intervals, respectively while shifted by 120 degrees each other in a rotational direction. It should be noted that the intervals have the same dimension in one embodiment, but may have different dimensions in another embodiment.

Each of the three rotary disks has a plurality of deformed holes, for example, nine deformed holes. The number of the deformed holes is optional. The deformed holes are formed through each of the three rotary disks and are arranged on a same or common circumference. Three deformed holes in the plurality of the deformed holes define knife edges or slits, respectively. Remaining deformed holes in the plurality of the deformed holes define light-passing openings as passages for the light beam, respectively. The same or common circumference means a rotation trajectory of the light-passing openings to which the knife edges or the slits pass according to rotation of the rotary disks.

A photodetector is arranged on the optical path of the light beam outside the set of the rotary disks in the transmission direction to be measured to receive the light beam passing through the three rotary disks.

The knife edges or the slits of the three rotary disks scan the light beam at three points in the optical path of the light beam during a single rotation of the three rotary disks. This results in accurately measuring a light beam profile of the light beam in real time. A calculation process is conducted to measurement data of the measuring result using a computer to find a beam diameter, a waist position, a spreading angle and a direction angle (or a transmission direction) of the light beam in real time.

In one embodiment, a bandpass filter is further used. The bandpass filter is arranged between an inlet port and the photodetector on the optical path of the light beam to reflect visible radiation only.

For the beam diameter of the light beam, full-width half-maximum (FWHM) is frequently used. According to FWHM, the beam diameter of the light beam to be found is a beam diameter of the light beam at a half maximum in light intensity according to distribution of the light intensity in a plane orthogonal to the transmission direction of the light beam. In a case of a Gaussian beam in which distribution of light intensity is centrosymmetric, the beam diameter of the light beam to be found is a beam diameter when the light intensity is 1/e squared of a maximum. Thus, the bandpass filter does not influence to the measurement of the beam diameter, the center and the like of the light beam as long as the bandpass filter ensures uniformity of in-plane light transmittance.

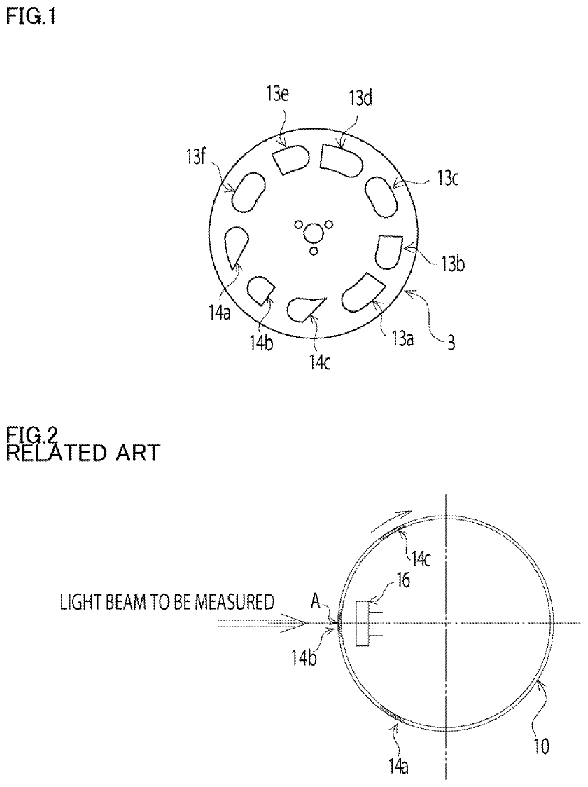

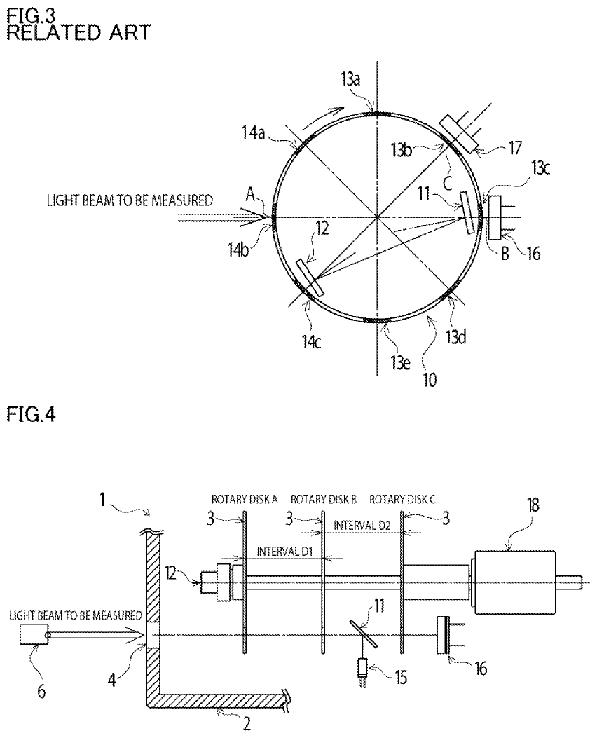

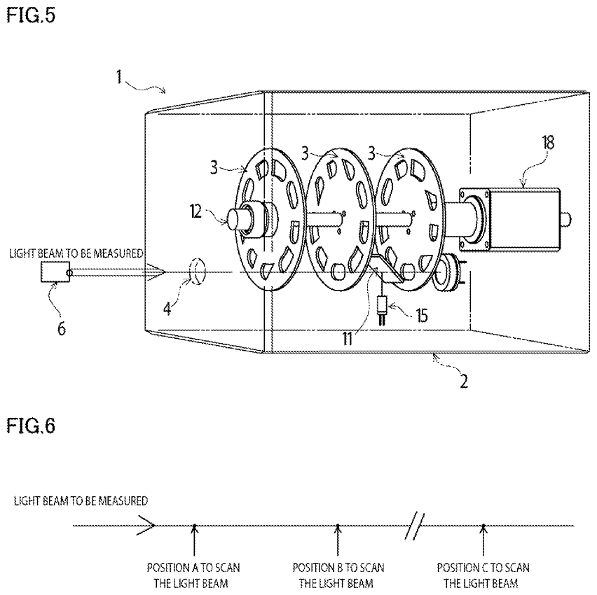

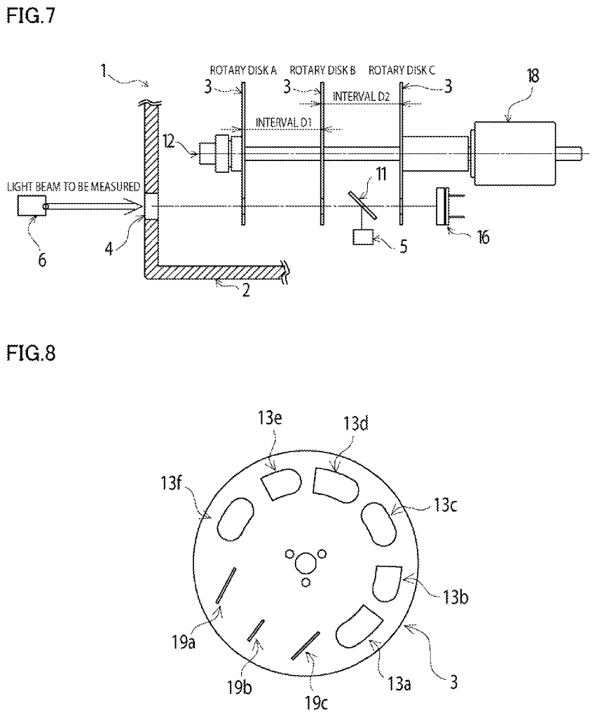

Hereinafter, a detailed embodiment will be explained with reference to drawings. FIG. 1 is a plan view illustrating a rotary disk having deformed holes used in an apparatus for measuring a light beam of an embodiment, FIG. 4 is a side view illustrating the apparatus for measuring a light beam according to the embodiment and FIG. 5 is a schematic perspective view illustrating the apparatus of the embodiment. In addition, a sectional shape of part of a case 2 is illustrated in FIG. 4. The same holds for FIG. 7.

An apparatus 1 for measuring a light beam profile of the embodiment has a case 2. In the case 2, three rotary disks 3 are fixed across a light beam to be measured on three positions A, B and C on a common rotary shaft 12 at regular intervals D1 and D2 so as to be integrally rotatable. The three rotary disks 3 fixed on the shaft 12 are shifted by 120 degrees each other in the rotational direction. The light beam is radiated from a light source 6 arranged outside the apparatus 1.

Each of the three rotary disks 3 has nine deformed holes formed therethrough. Three deformed holes in the nine deformed holes are non-circular holes including knife edges 14a, 14b and 14c, respectively. The knife edges 14a, 14b and 14c are linear edges of the deformed holes and arranged along different directions. In this embodiment, the knife edges 14a and 14c are inclined so as to be symmetric with respect to a radial direction of the rotary disk 3. The knife edge 14b is arranged along the radial direction.

Remaining six deformed holes of the nine deformed holes define light-passing openings 13a, 13b, 13c, 13d, 13e and 13f as passages for the light beam, respectively. The six deformed holes defining the light-passing openings 13a, 13b, 13c, 13d, 13e and 13f are non-circular holes that do not prevent the light beam scanned by the knife edges 14a, 14b and 14c on the other rotary disks 3 from passing through.

In addition, the number of the remaining deformed holes is six in this embodiment, but may be less than six by coupling two or more remaining deformed holes so as to form one deformed hole. Further, in a case that four or more deformed holes each defining knife edges, the number of the remaining deformed holes may be seven or more.

Circumferential distances between adjacent deformed holes on each of the rotary disks 3 are constant in this embodiment, but may be different from each other.

A photodetector 16 is arranged outside the set of the three rotary disks 3 on the optical path of the light beam to be measured in the transmission direction of the light beam to receive the light beam passing through the three rotary disks 3.

A motor 18 is connected to the rotary shaft 12 to drive and rotate the rotary shaft 12. The three rotary disks 3 rotate integrally with the rotary shaft 12 driven and rotated. During a single rotation of the rotary disks 3, each of the knife edges 14a, 14b and 14c of the rotary disks 3 scan the light beam one time at the three positions A, B and C on the optical path or a transmission axis of the light beam. This scanning enables a light beam profile of the light beam to be measured. The measurement data of the measuring result is subjected to a calculation process of a computer. According to the calculation process, a beam diameter, a waist position, a spreading angle, a direction angle and the like of the light beam are found in real time.

It should be noted that the principle to measure the light beam profile using the knife edges is commonly known and the detailed explanation of the principle is omitted.

The apparatus 1 according to this embodiment has a bandpass filter 11 for infrared and ultraviolet regions of the light beam. The bandpass filter 11 is arranged between an inlet port 4 and the photodetector 16 to reflect visible radiation only, the inlet port 4 which is formed through the case 2 to enter the light beam therethrough into the apparatus 1.

According to this embodiment, the bandpass filter 11 is arranged in one of the intervals D1 and D2, in particular in the interval D2, defined between the adjacent rotary disks 3 in the optical path of the light beam as illustrated in FIG. 5.

A visible light source 15 is arranged toward the bandpass filter 11 so that the visible light source 15 does not interfere the three rotary disks 3. The visible light source 15 is configured to radiate a collimator beam as the light beam. The collimator beam radiated from the visible light source 15 is reflected by the bandpass filter 11 and is exited from the inlet port 4. The exited collimator beam is used as a guide light for radiation of the light beam to be measured. As this result, it is easy to align the light beam.

In an alternative embodiment, a CCD camera 5 is arranged instead of the visible light source 15 as illustrated in FIG. 7. The CCD camera 5 is oriented to the bandpass filter 11 to capture an outside of the apparatus 1 through the inlet port 4. When the apparatus 1 is arranged, the apparatus 1 for measuring the light beam is adjusted so that an image of a light source 6 reflected by the bandpass filter 11 is captured by the CCD camera 5. This easily aligns the apparatus 1.

FIG. 8 is a plan view illustrating a rotary disk according to an alternative embodiment of the present invention. The rotary disk 3 of the alternative embodiment of FIG. 8 has slits 19a, 19b and 19c instead of the knife edge 14a, 14b and 14c. The slits 19a, 19b and 19c are defined by three deformed holes and are arranged along different directions. Each of the slits 19a, 19b and 19c has parallel edges and an angle of the parallel edges is different from angles of edges of the other slits. In addition, the principle to measure the light beam profile using the slits is commonly known and the detailed explanation of the principle is omitted.

It should be noted that the present invention is not limited to the aforementioned embodiments and various modifications and replacements are allowed within claims.

The present invention is applicable to optical axis adjustment of a laser beam, adjustment of a collimator beam for a transceiver module of optical communication, measurement of a light focal position and the like.

What is claimed is:

1. An apparatus for measuring a light beam profile, comprising:
three rotary disks arranged at intervals on an optical path of a light beam to be measured and being integrally rotatable;
a plurality of deformed holes formed through each of the three rotary disks and arranged on a same circumference;
knife edges or slits defined by three deformed holes in said plurality of the deformed holes of each of the three rotary disks so as to be arranged along different directions, respectively;
passages for the light beam defined by remaining deformed holes in said plurality of the deformed holes of each of the three rotary disks excluding the three deformed holes defining the knife edges or the slits, respectively; and
a photodetector arranged on the optical path of the light beam to receive the light beam passing through the three rotary disks.

2. The apparatus according to claim 1, further comprising:
a rotary shaft to which the three rotary disks are fixed at the intervals on the optical path, the three rotary disks shifted by 120 degrees each other in a rotational direction.

3. The apparatus according to claim 1, further comprising:
an inlet port from which the light beam enters;
a bandpass filter arranged between the inlet port and the photodetector on the optical path of the light beam to reflect visible radiation only; and
a collimator light source arranged to radiate a visible radiation beam to the bandpass filter, wherein
the visible radiation beam reflected by the bandpass filter is used as a guide light for an optical axis of the apparatus.

4. The apparatus according to claim 1, further comprising:
an inlet port from which the light beam enters;
a bandpass filter arranged between the inlet port and the photodetector on the optical path of the light beam to reflect visible radiation only; and
a camera arranged to be oriented to the bandpass filter to capture an outside of the apparatus through the inlet port
